(19) United States
(12) Patent Application Publication
(10) Pub. No.: US 2015/0123915 A1
(43) Pub. Date: May 7, 2015

(54) PORTABLE TERMINAL, CONTROL METHOD AND PROGRAM

(71) Applicant: KYOCERA Corporation, Kyoto-shi, Kyoto (JP)

(72) Inventors: Tomoki Iwaizumi, Kyoto-shi (JP); Takashi Takahara, Kyoto-shi (JP); Yoshinori Kida, Kyoto-shi (JP)

(21) Appl. No.: 14/404,932

(22) PCT Filed: May 28, 2013
(86) PCT No.: PCT/JP2013/003372

§ 371 Date: Dec. 1, 2014

(30) Foreign Application Priority Data
May 29, 2012 (JP) 2012-121946

(51) Int. Cl. G06F 3/041; G06F 3/0484

(52) U.S. Cl. CPC G06F 3/0418; G06F 3/04845; G06F 3/041
USPC 345/173

(57) ABSTRACT

A mobile terminal includes a touch panel. When a touch is detected on the touch panel, and the position of the touch is judged to be within a specific area set in advance in the periphery of the touch panel, then processing associated with the touch is not executed, and a display update is instead executed to bring a display position of a specific display object having a distant positional relationship with the touch position closer to the touch position. When the touch is not within the specific area, the processing associated with the touch is executed.

### TECHNICAL FIELD

The present disclosure pertains to a mobile terminal such as mobile telephone device, and particularly to execution control technology for processing based on input to a touch panel.

### BACKGROUND ART

In the field of mobile terminal, there is demand for small case sizes that maintain portability as well as for large screen sizes that expand visibility.

As it happens, for mobile terminals that incorporate a touch panel, keeping the case size small while expanding the size of the screen (touch panel) leads to the touch panel being installed as far as the edges of the case. Accordingly, in such situations, a user holding the mobile terminal is likely to unintentionally touch the touch panel with a finger or the like. As a result, when an icon or other display object with associated predetermined processing is displayed in an area touched by the user, a problem occurs in that processing may be executed that the user does not intend (hereinafter termed a mistaken operation).

In response to this problem, technology has been used to prevent icons and the like from being at a specific position in the periphery of the touch panel (e.g., Patent Literature 1). In such cases, mistaken operations are prevented from occurring when the user holds the case with a finger at the specific position.

### CITATION LIST

### Patent Literature

### [Patent Literature 1]

Japanese Patent Application Publication No. 2012-73721

### SUMMARY OF INVENTION

### Technical Problem

However, there is also a need to constrain mistaken operations from occurring while the user is operating the mobile terminal, and not only when the mobile terminal is holding the case. The method disclosed by Patent Literature 1 makes no particular consideration of mistaken operations occurring during operation by the user.

In consideration of the above-described problem, a mobile terminal is provided that enables the occurrence of mistaken operations to be constrained while the user is operating the mobile terminal.

### Solution to Problem

In order to address the above-described problem, the present disclosure provides a mobile terminal, including: a touch panel; a display control unit controlling display of one or more display objects on the touch panel; a detection unit detecting a touch on the touch panel; a judgement unit judging whether a position of the touch detected on the touch panel is within a specific area arranged in advance at a periphery of the touch panel; and an execution control unit executing processing associated with the touch when the judgement unit judges that the position of the touch is not within the specific area, and refraining from executing the processing associated with the touch when the judgement unit judges that the position of the touch is within the specific area, wherein when the judgement unit judges that the position of the touch is within the specific area, the display control unit performs a display update of bringing a display position of a specific display object closer to the position of the touch, the specific display object being distant from the position of the touch in a set positional relationship.

### Advantageous Effects of Invention

According to the mobile terminal pertaining to the disclosure as described above, the occurrence of mistaken operation is constrained while the user is operating the mobile terminal.

### BRIEF DESCRIPTION OF DRAWINGS

FIG. 1 shows a front view of the external appearance of a mobile telephone device 100.

FIG. 2 illustrates the arrangement of specific areas.

FIG. 3 shows a display on the mobile telephone device 100.

FIG. 4 shows an example of a user operation.

FIG. 5 shows a display example of the scroll display.

FIG. 6 shows a display example of the magnification display.

FIG. 7 is a block diagram showing the main functional configuration of the mobile telephone device 100.

FIG. 8 shows the relationship between display object data and portion data for the scroll display.

FIG. 9A shows a region Ta for portion data before the magnification display, and FIG. 9B shows a region Tc for portion data after the magnification display.

FIG. 10 shows a data configuration and sample content of a specific area table 10.

FIG. 11A illustrates user operations for setting display settings information 20 (part 1), and FIG. 11B further illustrates the user operations for display settings information 20 (part 2).

FIG. 12 is a flowchart indicating control processing by the mobile telephone device 100.

FIGS. 13A-13D each show another example of an arrangement for the specific areas (examples 1-4).

FIGS. 14A and 14B each show a further example of an arrangement for the specific areas (examples 5-6).

FIGS. 15A-15D each show an example of an arrangement for the specific areas in the vicinity of the right-hand periphery of the touch panel 110 (examples 1-4).

FIG. 16 illustrates the arrangement of the specific areas in a situation where the specific areas change in accordance with screen orientation.

### DESCRIPTION OF EMBODIMENTS

A mobile telephone device is described below as an Embodiment of a mobile terminal pertaining to the disclosure.

### 1. Embodiment

### 1-1. Overview

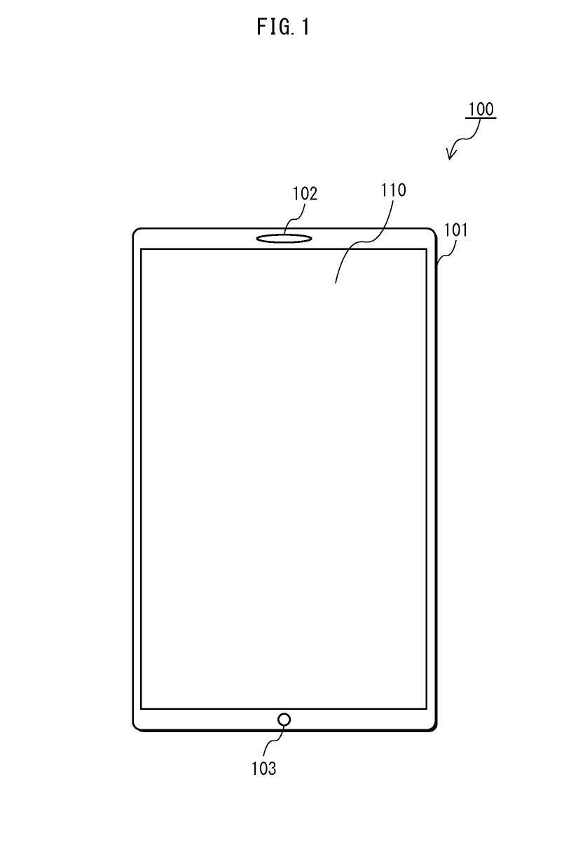

FIG. 1 shows a front view of the external appearance of a mobile telephone device 100.

As shown, the mobile telephone device 100 is a slate-type terminal, and includes a case 101 in which are disposed a receiver 102, a microphone 103, and a touch panel 110.

As seen, the touch panel 110 is disposed as far as the edges of the case 101. Thus, a user attempting to operate the large screen of the mobile telephone device 100 may, for instance, unintentionally touch the touch panel with a finger or the like. There is a risk of mistaken operation when such contact occurs at a position of an icon or other display object corresponding to predetermined processing.

To suppress such errors, the mobile telephone device 100 is provided in advance with specific areas at the periphery of the touch panel 110. Then, when the position of a detected touch is within the specific area, processing associated with an icon or the like in the touched position is constrained from being executed.

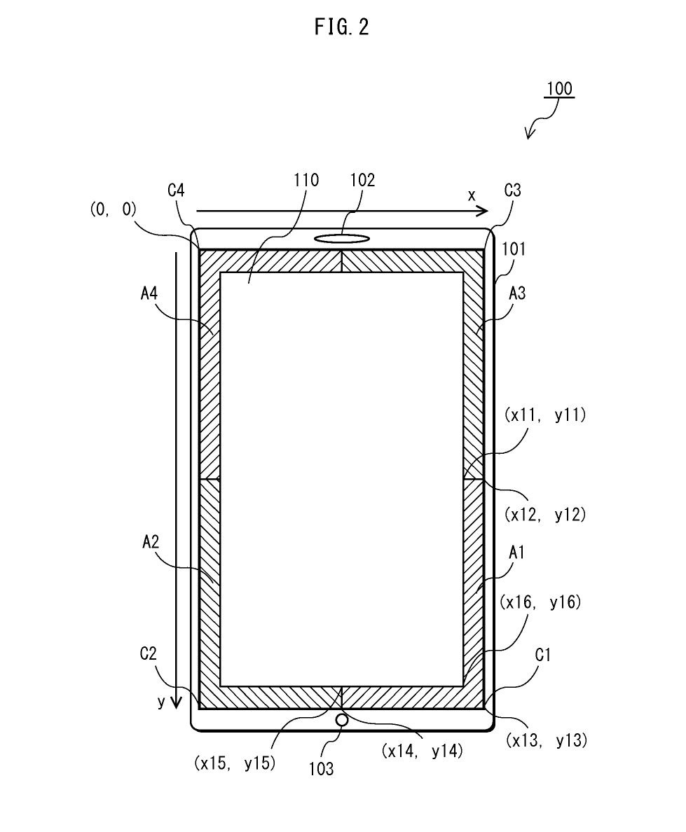

FIG. 2 illustrates the arrangement of the specific areas.

Here, corners C1-C4 of the touch panel 110, which is rectangular, each correspond to a corner in the vicinity of the specific areas. For instance, corner C1 is a corner in the vicinity of specific area A1. The term rectangular includes rectangles having rounded or bevelled corners.

When the position of a detected touch is within any one of the specific areas A1-A4, the mobile telephone device 100 does not execute processing associated with an icon or similar display object displayed at the touch position. This enables mistaken operations to be appropriately prevented from occurring.

When the detected position of the touch is within one of the specific areas, the mobile telephone device 100 also performs display control processing for improving operability.

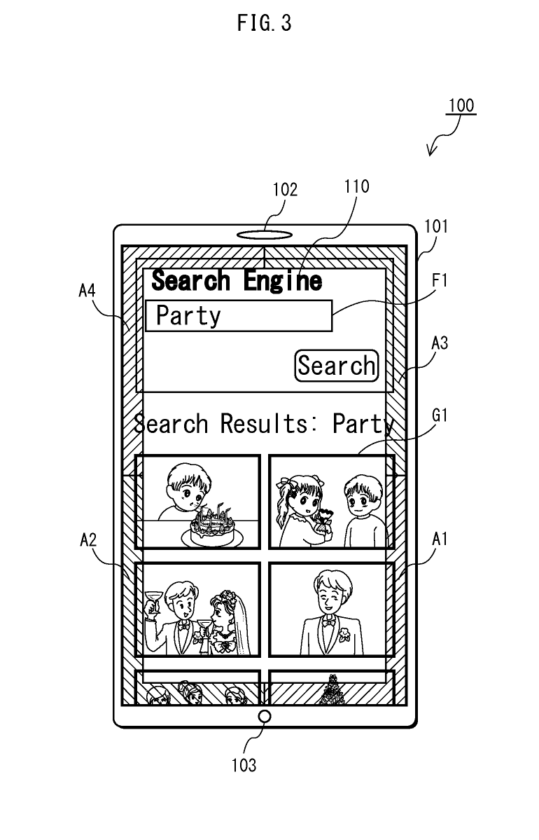

Display examples are shown in FIGS. 3-6, concerning situations where a touch is detected in specific area A1.

### 1-2. Display Examples

FIG. 3 shows an example of a web browser screen being executed by the mobile telephone device 100.

As shown, a search engine for videos is being used with the key word “party” having been entered into a keyword entry field F1, and the touch panel 110 displays the search results obtained. From this screen, the user may touch thumbnail image G1, for example, to begin playback of the video corresponding to thumbnail image G1.

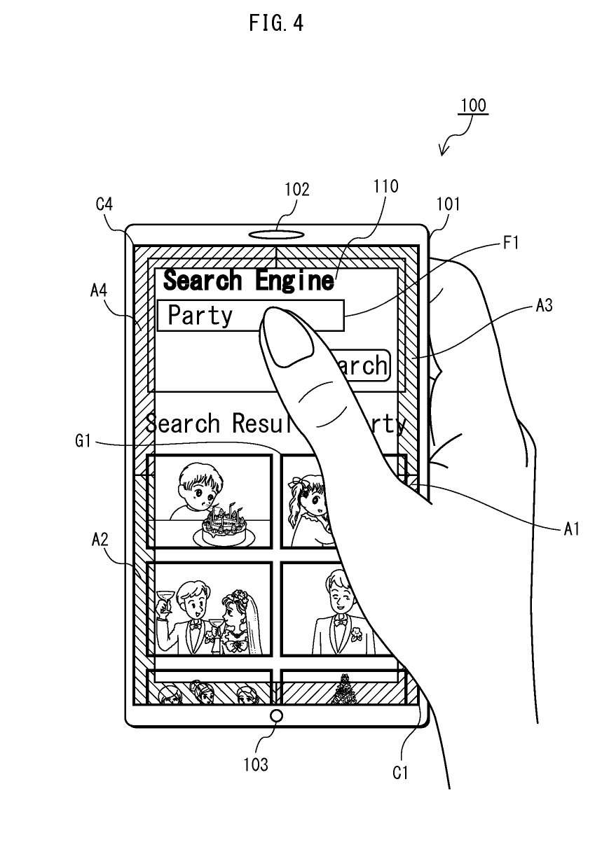

When the user holding the mobile telephone device 100 right-handedly attempts to enter a new keyword in the keyword entry field F1, for example, by touching the keyword entry field F1 with the thumb of the right hand, the ball of the thumb may come into contact with thumbnail image G1 displayed in specific area A1 (see FIG. 4).

In this situation, the mobile telephone device 100 does not execute the playback processing for the video associated with the thumbnail image G1 because the touch is located within specific area A1, and further executes display control processing as described below. The mobile telephone device 100 performs a display update to bring a display position of a display object in the vicinity of corner C4, which is opposite corner C1 near specific area A1 where the touch has been detected, nearer to corner C1. Specifically, the mobile telephone device 100 performs one of a scroll display and a magnification display, in accordance with later-described user settings.

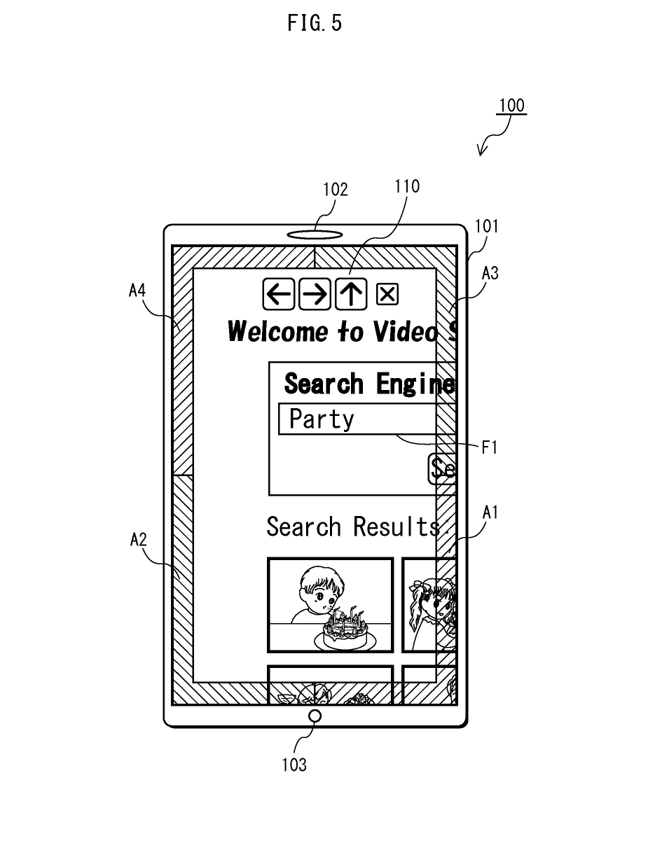

FIG. 5 shows a display example of the scroll display.

As shown, the display objects of FIG. 4 are displayed in a scroll display where the objects have been shifted from corner C4 toward corner C1.

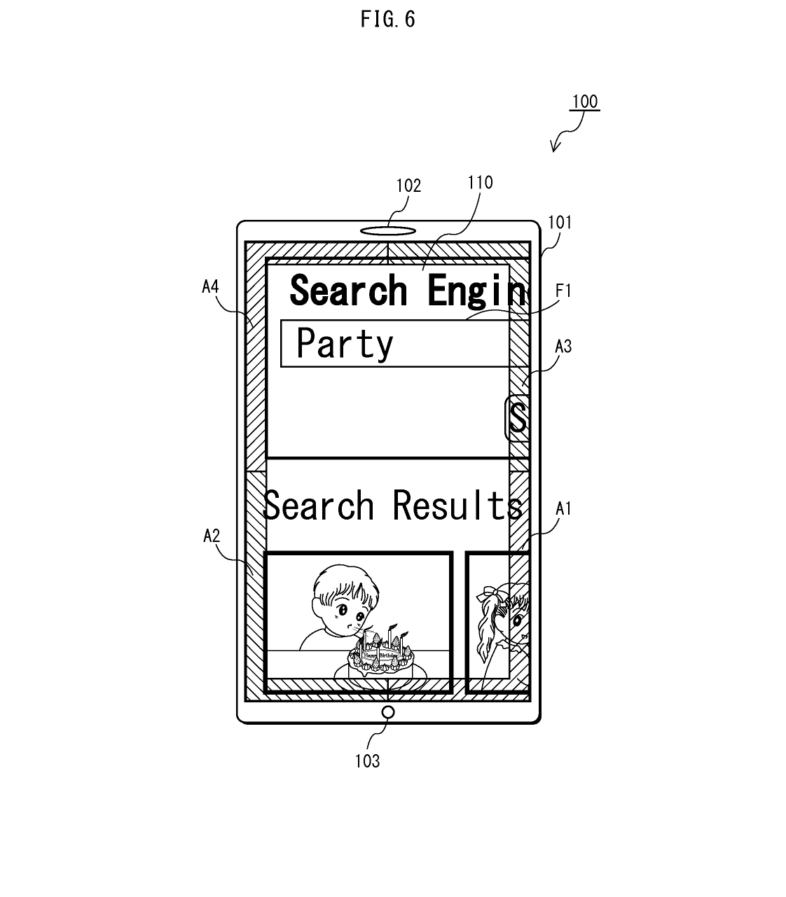

FIG. 6 shows a display example of the magnification display.

As shown, the display objects of FIG. 4 are displayed in an magnification display based on the position of corner C4.

Thus, as a result of performing the scroll display or the magnification display, the keyword entry field F1 that the user attempted to touch with the thumb is brought closer to the user's right hand, in comparison to the situation shown in FIG. 4. The user is therefore better able to easily touch the keyword entry field F1.

### 1-3. Functional Configuration

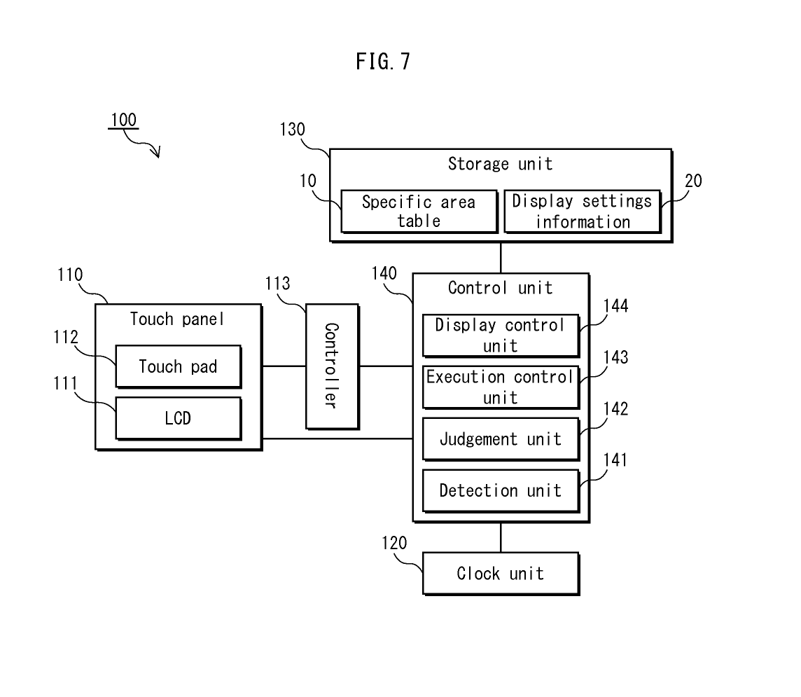

FIG. 7 is a block diagram showing the main functional configuration of the mobile telephone device 100.

As shown, the mobile telephone device 100 includes the touch panel 110, a controller 113, a clock unit 120, a storage unit 130, and a control unit 140.

The mobile telephone device 100 also includes a processor and memory. The functions of the control unit 140 are realised by the processor executing a program stored in memory.

The touch panel 110 includes a liquid crystal display (hereinafter, LCD) 111 and a touchpad 112. In the present Embodiment, the LCD 111 has pixels at a resolution of 480×800, for example.

Here, the touchpad 112 is a capacitive touch sensor provided over the surface of the LCD 111. The touchpad 112 is made using an optically transmissive material, enabling an image displayed on the LCD 111 to remain visible.

The controller 113 is an integrated circuit (hereinafter, IC) detecting a touch of a finger or the like made by the user on the touchpad 112. While detecting, the controller 113 outputs coordinates (x, y) of the location of the touch on the touchpad to the control unit 140 at a fixed interval (e.g., every 25 ms).

The touch operations performed by the user on the touchpad 112 include a tap, a double-tap, a long tap, a flick, a slide, and so on.

Specific examples of these touch operations are given below.

A tap is an operation of the user touching the touchpad 112 with a finger and then removing the finger from the touchpad 112 within a short time.

A double-tap is an operation of performing the tap operation on the touchpad 112 twice within a short time.

A long tap is an operation of continuously touching the touchpad 112 with the finger for longer than a predetermined time and then removing the finger from the touchpad 112.

A flick is an operation of flicking the finger in a particular direction along the touchpad 112. Specifically, a flick is an operation of touching the touchpad 112 with the finger and then flicking the finger at a predetermined speed toward a particular direction.

A slide is an operation of touching the touchpad 112 with a finger and then moving the finger in a particular direction.

The above operations performed by the user on the touchpad 112 are collectively called touch operations in the following explanations.

When a touch operation is performed outside the specific areas, the mobile telephone device 100 executes processing based on the touch operation. When touch operations of a tap and a long tap are performed within a specific area, the mobile telephone device 100 does not perform the processing associated with these touch operations. For example, when an application being executed (e.g., a web browser) is displayed on the touch panel 110, and a tap or a long tap are performed outside the specific area, the mobile telephone device 100 displays a menu screen. However, when a tap or a long tap are performed within the specific area, the menu screen is not displayed. Accordingly, this prevents a menu screen from being displayed due to a tap or long tap in the specific area before the scroll display or the magnification display are performed.

The clock unit 120 begins to track time in response to an instruction from the control unit 140 and, once a fixed interval (e.g., 5 seconds) has elapsed, makes a notification to such effect to the control unit 140 by, for example, executing a timer or counter. The fixed interval tracked by the clock unit 120 is set in advance by the manufacturer of the mobile telephone device 100.

The storage unit 130 stores data required for the mobile telephone device 100 to run programs and applications (e.g., a phone application, a mail application, a web browser, and so on), as well as memory areas for a specific area table 10 and for display settings information 20.

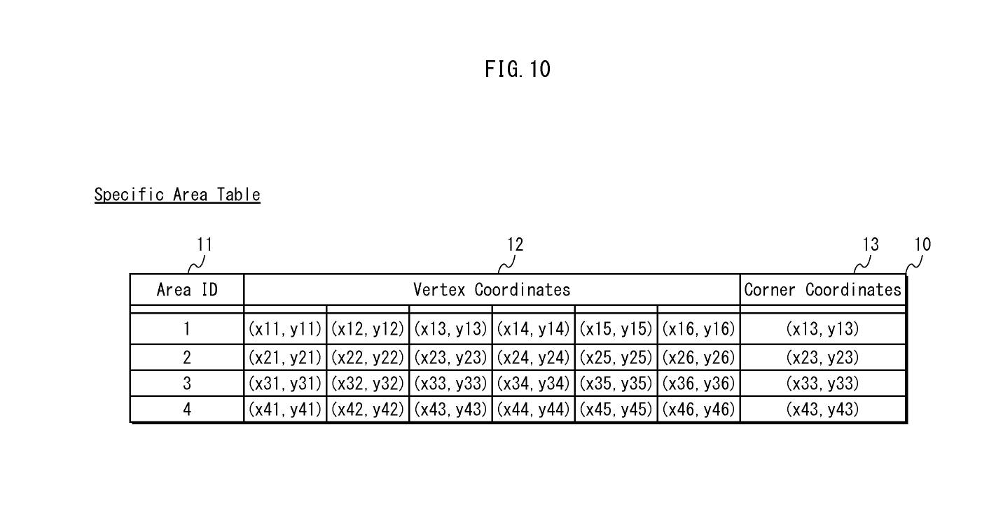

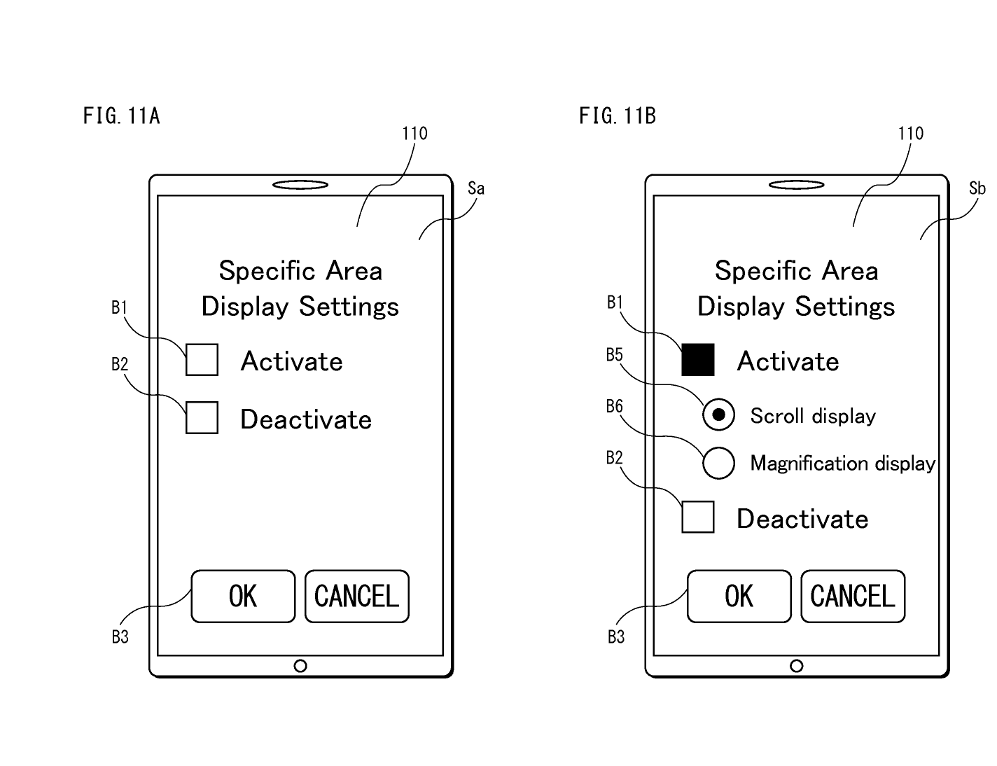

The specific area table 10 is a table in which are registered a range of the specific areas (A1-A4) and a position of a respective neighbouring corner (see FIG. 10). The display settings information 20 is information indicating one of the scroll display and the magnification display as processing to be performed when a touch is detected in one of the specific areas. The setting methods of the specific area table 10 and the display settings information 20 are described later (see FIGS. 11A and 11B).

The control unit 140 executes general functions of the mobile telephone device, and specifically processes execution control and display control in response to the position of a touch on the touch panel 110. The control unit 140 also updates the content of the display settings information 20 in the storage unit 130 in accordance with user operations. The control unit 140 includes a detection unit 141, a judgment unit 142, an execution control unit 143, and a display control unit 144.

The detection unit 141 detects a touch on the touch panel 110 according to coordinates received from the controller 113.

The judgment unit 142 judges whether a position at which the detection unit 141 has detected a touch is within any of the specific area, based on the specific area table 10 in the storage unit 130.

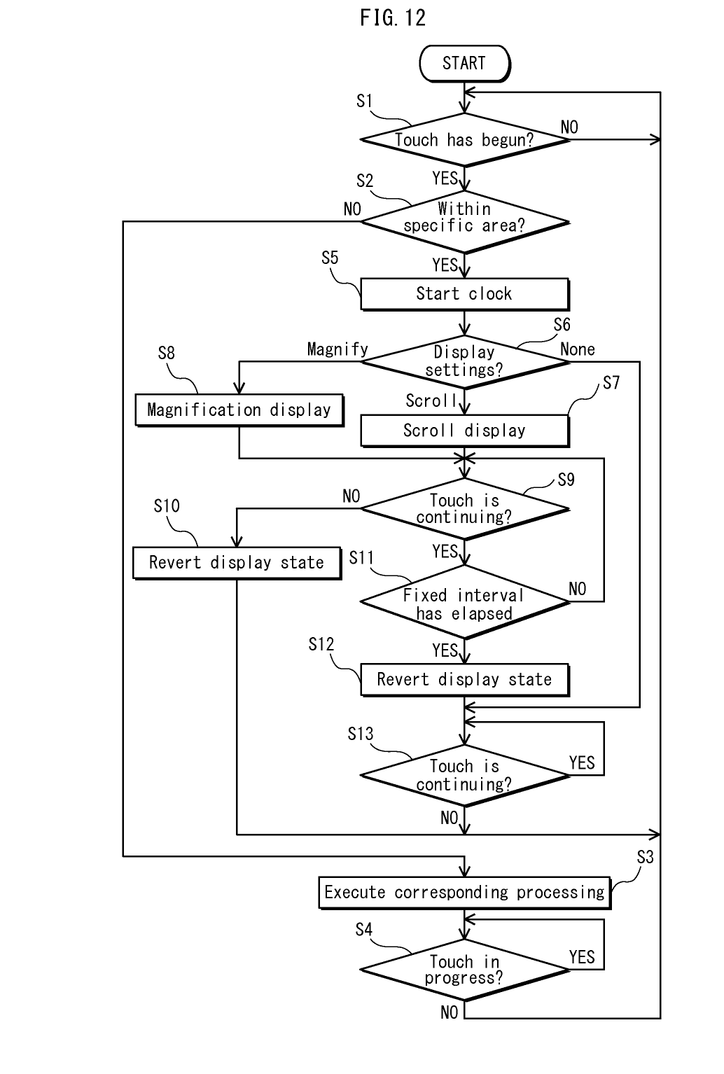

The execution control unit 143 reads application programs from the storage unit 130 in response to user operations, and controls whether or not a process corresponding to the position of the touch detected on the detection unit 141 is performed in response to judgement results from the judgment unit 142. The processing by the execution control unit 143 is described later (see FIG. 12).

The display control unit 144 performs the scroll display or the magnification display in accordance with the display settings information 20 in the storage unit 130 when the position of the touch detected by the detection unit 141 is judged by the judgment unit 142 to be within one of the specific areas.

The display control method of the display control unit 144 is specifically described below, with reference to FIGS. 3-6.

The scroll display is explained first.

In the present Embodiment, the scroll display is performed by consecutively switching data of a display size for actual display (hereinafter, portion data) within the data subject to display (hereinafter, display object data) for repeated display on the touch panel 110.

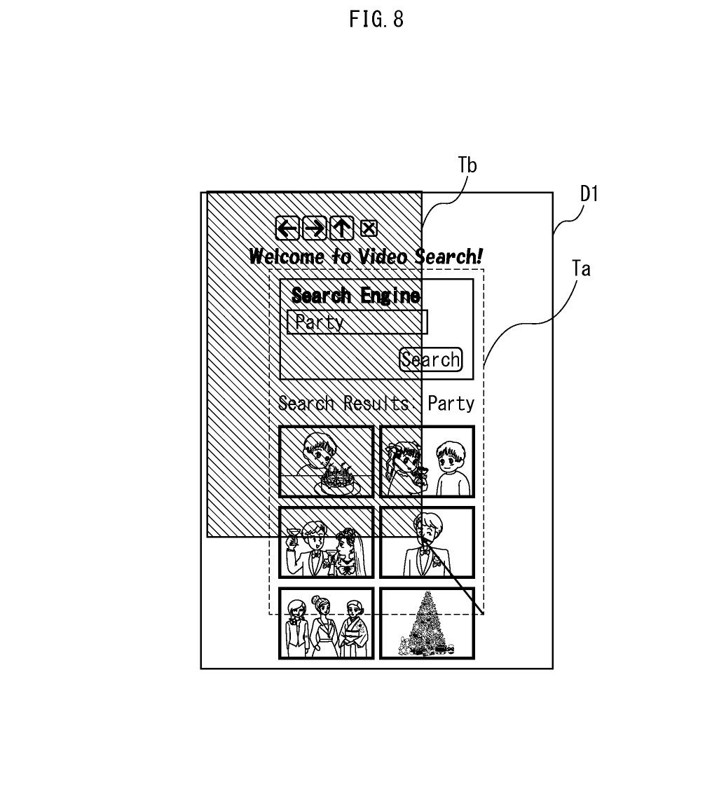

FIG. 8 shows display object data D1, region Ta in which the scroll display of the portion data has not yet started, and region Tb in which the scroll display of the portion data is complete.

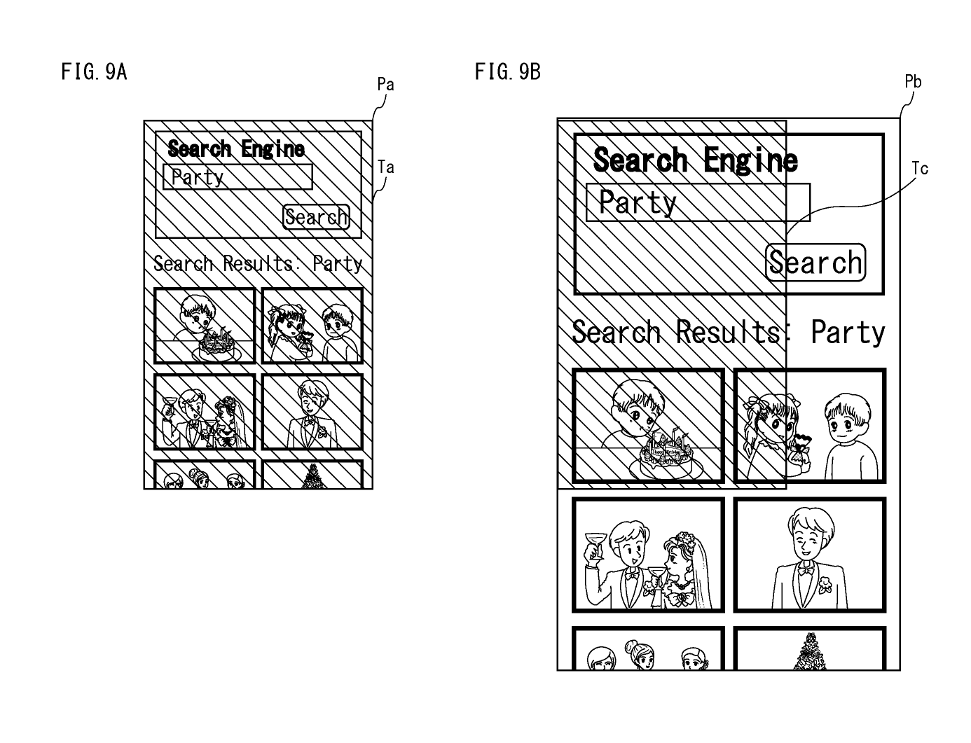

Here, region Ta is a display region for the portion data displayed on the touch panel 110 in the example of FIG. 3. This is also the case for later-described FIG. 9A. Also, region Tb of FIG. 8 is a display region for the portion data displayed on the touch panel 110 in the example of FIG. 5.

When the display settings information 20 indicate that scroll display is to be performed, and the image of FIG. 3 is displayed on the touch panel 110, then as shown in FIG. 4, the user holding the mobile telephone device 100 right-handedly touches thumbnail image G1 displayed in specific area A1 with the base of the thumb. Once this occurs, the display control unit 144 performs the scroll display by shifting the display region of the portion data by a fixed amount (e.g., a number of dots) from display region Ta of FIG. 8 to the position of region Tb and displaying the shifted portion data in the display region on the touch panel 110.

The shift direction for shifting the portion data from region Ta to region Tb is the direction shown in FIG. 2 from corner C1 to the opposite corner C4. In the present Embodiment, the amount of shifting applied to the portion data from region Ta to region Tb is a fixed amount set in advance by the manufacturer of the mobile telephone device 100.

The magnification display is described next.

FIG. 9A shows region Ta of portion data Pa before the magnification display, and FIG. 9B shows magnified data Pb, which is a magnification of portion data Pa, and region Tc, which is portion data.

Here, region Tc is a display region for the portion data displayed on the touch panel 110 in the example of FIG. 6.

When the display settings information 20 indicate that magnification display is to be performed and the image of FIG. 3 is displayed on the touch panel 110, then as shown in FIG. 4, the user holding the mobile telephone device 100 right-handedly touches thumbnail image G1 displayed in specific area A1 with the base of the thumb. Once this occurs, the display control unit 144 expands portion data Pa using the upper-left vertex of portion data Pa shown in FIG. 9A as a reference (corresponding to the position of corner C4 in FIG. 4), and sets the portion data area to area Tc such that the upper-left vertex position of now-magnified data Pb matches the upper-left vertex of the portion data. The display control unit 144 then performs the magnification display by displaying the portion data set into region Tc on the touch panel 110.

In the present Embodiment, the magnification ratio of magnified data Pb relative to portion data Pa is a fixed value set in advance by the manufacturer of the mobile telephone device 100.

### 1-4. Data

The specific area table 10 is described below with reference to FIG. 10.

FIG. 10 shows the data configuration and sample content of the specific area table 10.

As shown, the specific area table 10 includes an area ID column 11, a vertex coordinates column 12, and a corner coordinates column 13.

The area ID column 11 lists identification information for each of the specific areas. In this example, the area IDs respectively identifying the specific areas A1 through A4 are numbers 1 through 4.

The vertex coordinates column 12 lists information indicating coordinates of the vertex in the specific area corresponding to the area ID. As shown in FIG. 2, the coordinates listed in the vertex coordinate column 12 are given in a coordinate system having a rightward distance on the x axis and a downward distance on the y axis, using the upper left corner of the touch panel 110 as the origin (0, 0).

The corner coordinate column 13 lists information indicating coordinates of a corner in the vicinity of the specific area corresponding to the area ID.

For instance, for the specific area (A1) having the area ID 11 of 1, the vertex coordinate column 12 gives coordinates (x11, y11), (x12, y12), (x13, y13), (x14, y14), (x15, y15), and (x16, y16), and the corner coordinate column gives coordinates (x13, y13).

### 1-5. Display Settings Information Setting Method

The setting method for the display settings information 20 is described below with reference to FIGS. 11A and 11B.

FIGS. 11A and 11B are intended to illustrate user operations made to set the display settings information 20.

When the user selects Specific Area Display Settings among setting menu items that are currently selectable, screen Sa of FIG. 11A is displayed on the touch panel 110.

When a touch has been detected in any of the specific areas, screen Sa enables the user to select whether or not to perform the scroll display and the magnification display. FIG. 11A also indicates that neither of checkboxes B1 and B2 has been checked, that is, that no choice has yet been made.

From screen Sa, the user touches the display position of checkbox B2 with a finger or the like, thereby making a selection operation on checkbox B2, and then makes a selection operation on OK button B3. Afterward, the control unit 140 updates the display settings information 20 in the storage unit 130 to indicate that the scroll display and the magnification display are not to be performed.

When the user performs a selection operation on checkbox B1, screen Sb of FIG. 11B is displayed on the touch panel 110.

Screen Sb enables the user to designate whether the scroll display or the magnification display is to be performed. In this example, radio button B5 is selected. That is, the scroll display is selected.

When the user performs a selection operation on radio button B5 and on OK button B3 from screen Sb, the control unit 140 updates the display settings information 20 in the storage unit 130 to indicate that the scroll display is to be performed. Also, when the user performs a selection operation on radio button B6 and on OK button B3 from screen Sb, the control unit 140 updates the display settings information 20 in the storage unit 130 to indicate that the magnification display is to be performed.

### 1-6. Operations

The operations of the mobile telephone device 100, configured as described above, are described below with reference to FIG. 12.

FIG. 12 is a flowchart of the control process performed by the control unit 140 of the mobile telephone device 100. The control process indicated by FIG. 12 begins when the mobile telephone device 100 is powered ON and, although not specifically indicated, ends when powered OFF.

Initially, when the mobile telephone device 100 is powered ON, the detection unit 141 of the control unit 140 judges whether a touch has begun on the touch panel 110 (step S1). When no coordinates have been output by the controller 113, the detection unit 141 judges that no touch as begun (NO in step S1) and repeats step S1.

When coordinates have been output by the controller 113, the detection unit 141 judges that a touch has begun (YES in step S1). The judgment unit 142 then judges whether the position of the touch indicated by the coordinates output by the controller 113 is within any one of the specific areas A1-A4 (step S2).

When the coordinates output by the controller 113 are not within any one of the specific areas defined by the specific area table 10, the judgment unit 142 judges that the touch position is not within any specific area (NO in step S2). The execution control unit 143 executes control corresponding to the touch position (step S3). When no icon or similar display object with associated defined processing is displayed at the touch position, the execution control unit 143 does not perform any processing in response to the touch position.

When the processing of step S3 is complete, the detection unit judges whether the touch begun in step S1 is continuing (step S4). In the affirmative case (YES in step S4), the processing of step S4 is repeated. In the negative case (NO in step S4), the detection unit 141 repeats the process from step S1.

However, when the coordinates output by the controller 113 are within the coordinate range of any one of the specific areas indicated in the specific area table 10, the judgment unit 142 judges that the touch position is within one of the specific area (YES in step S2), and the clock unit 120 begins tracking time (step S5).

Next, the display control unit 144 determines the content of the display settings indicated by the display settings information 20 in the storage unit 130 (step S6).

When the display settings information 20 indicates that neither of the scroll display and the magnification display are to be executed (None in step S6), the display control unit 144 performs neither of the scroll display and the magnification display, and the detection unit 141 judges whether the touch begun in step S1 is continuing as in step S4 (step S13). While the touch is continuing (YES in step S13), the detection unit 141 repeats the processing step S13. Once the touch ends (NO in step S13), the process repeats from step S1.

When the display settings information 20 indicates that the scroll display is to be performed (Scroll in step S6), the display control unit 144 performs the scroll display (step S7). When the display settings information 20 indicates that the magnification display is to be performed (Magnify in step S6), the display control unit 144 performs the magnification display (step S8).

When the processing of step S7 or S8 is complete, the detection unit judges whether the touch begun in step S1 is continuing, as performed in step S4 (step S9). When the detection unit 141 judges that the touch is not continuing (NO in step S9), the display control unit 144 restores display state of the touch panel 110 to those in place immediately before processing of step S7 or S8 began (step S10). That is, when the display state of the touch panel 110 is executing the process of step S7, the display state from before the scroll display is restored. Likewise, when the display state of the touch panel 110 is executing the process of step S8, the display state from before the magnification display is restored. For example, when the scroll display or the magnification display shown in FIGS. 5 and 6 is performed, the display state of the touch panel 110 is restored to that shown in FIG. 3.

When the processing of step S10 is complete, the detection unit 141 repeats the process from step S1.

When the detection unit 141 judges that the touch is continuing (YES in step S9), the display control unit 144 judges whether or not a fixed interval has elapsed since the touch began (step S11). This fixed interval is set to be longer than the predetermined time used to specify a touch operation as a long tap performed on the touchpad 112.

In the absence of a notification from the clock unit 120, the display control unit 144 judges that the fixed interval has not yet elapsed (NO in step S11) and the detection unit 141 repeats the process from step S9.

When there is a notification from the clock unit 120, the display control unit 144 judges that the fixed interval has elapsed (YES in step S11) and, as described for step S10 above, restores display conditions of the touch panel 110 to those in place immediately before processing of step S7 or S8 began (step S12).

The detection unit 141 also performs the determination process of step S13 and, in the negative case (NO in step S13), repeats the process from step S1.

### 2. Supplement

The mobile terminal pertaining to the present disclosure has been described above with reference to the Embodiment. However, the following variation are also applicable. Naturally, no limitation is intended to the mobile telephone device according to the above-described Embodiment.

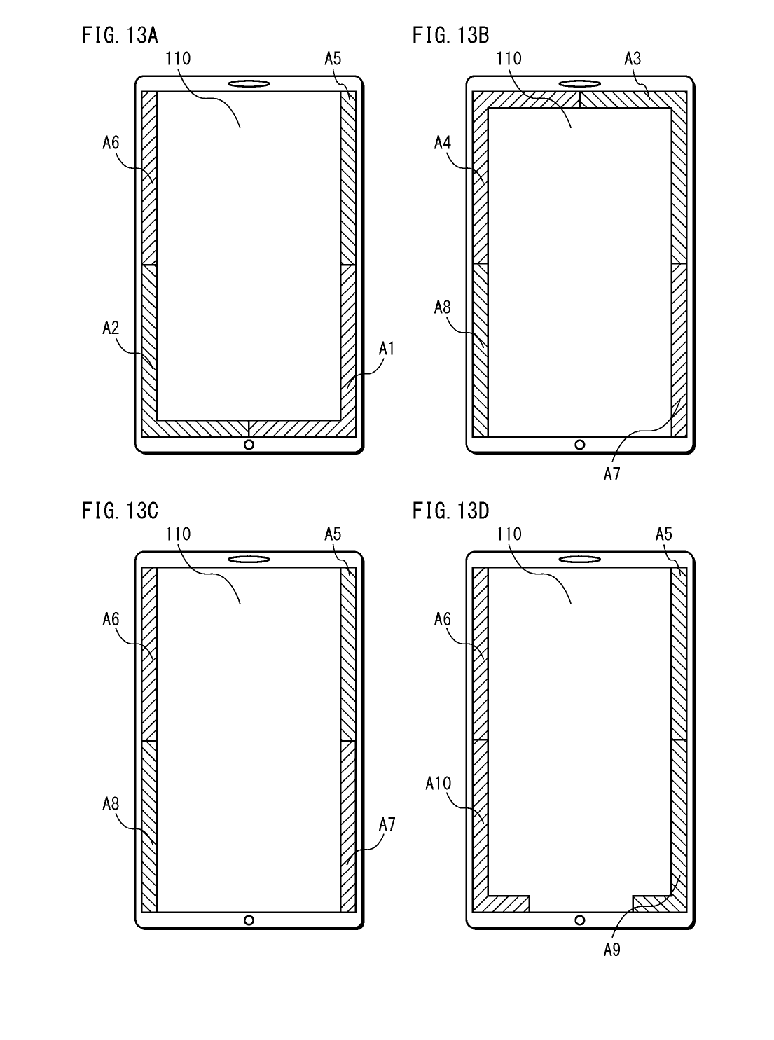

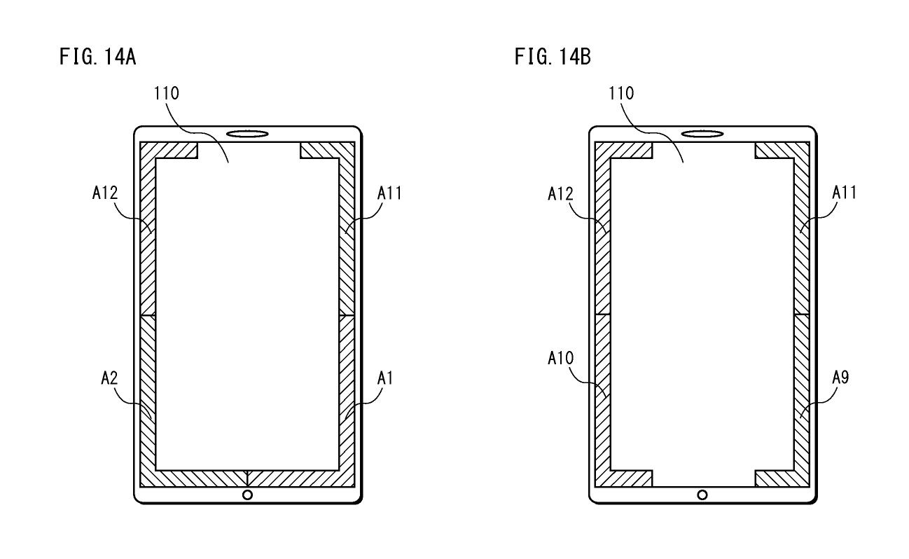

(1) In the Embodiment, the specific areas are set up as shown in FIG. 2. However, this is intended only as an example. The specific areas may be set up in any regions where a mistaken operation could occur on the touch panel 110. For example, the specific areas may be set up as shown in FIGS. 13A-13D and FIGS. 14A-14B.

FIGS. 13A-13D and 14A-14B show other examples of the specific area setup.

FIG. 13A shows rectangular specific areas A5 and A6 replacing specific areas A3 and A4 shown in FIG. 2. FIG. 13B shows rectangular specific areas A7 and A8 replacing specific areas A1 and A2 shown in FIG. 2. FIG. 13C shows identical rectangular specific areas A5-A8. FIG. 13D shows specific areas A9 and A10 replacing specific areas A1 and A2 of FIG. 13A, where specific areas A9 and A10 do not share a boundary.

FIG. 14A shows specific areas A11 and A12 replacing specific areas A3 and A4 of FIG. 2, where specific areas A11 and A12 do not share a boundary. FIG. 14B shows specific areas A9 and A10 of FIG. 13D replacing specific areas A1 and A2 of FIG. 14A.

These variations reduce the range of the specific areas, convert the specific areas from polygons to rectangles, and so on, which reduces the processing load imposed when judging whether a touch is within the specific areas.

The respective corners in the vicinity of each of the specific areas are set as shown in FIG. 2. That is, corner C3 is in the vicinity of specific areas A5 and A11 and corner C4 is in the vicinity of specific areas A6 and A12. Similarly, corner C1 is in the vicinity of specific areas A7 and A9 and corner C2 is in the vicinity of specific areas A8 and A10.

(2) In the above Embodiment and in FIGS. 13A-13D and 14A-14B, the specific areas are four in number. However, this is only intended as an example. One or more specific areas may be provided. That is, the four specific areas shown in each of FIGS. 2, 13A-13D, and 14A-14B may be provided as a single specific area, where the single specific area combines the four specific areas corresponding to corners C1-C4.

Also, the specific areas may be provided in the vicinity of only one of a right-hand side and a left-hand side of the touch panel 110.

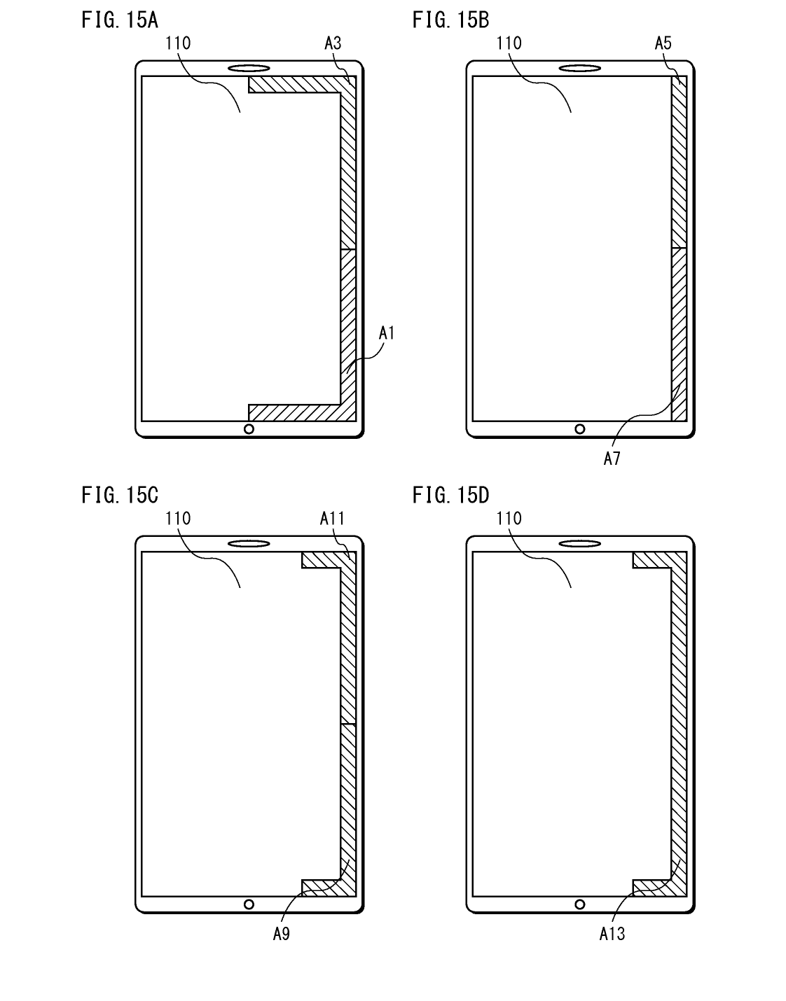

FIGS. 15A-15D show examples in which the specific area is set only in the vicinity of the right-hand side of the touch panel 110.

In such cases, two specific areas may be provided as shown in FIGS. 15A-15C, or a single specific area may be provided as shown in FIG. 15D. FIG. 15D shows an example in which specific area A13 is provided as a combination of specific areas A9 and A11 shown in FIG. 15C. Of course, any two areas other than shown in FIG. 15C may also be combined into a single specific area in this manner. For instance, specific areas A1 and A3 shown in FIG. 15A, specific areas A5 and A7 shown in FIG. 15B, specific areas A1 and A5 shown in FIG. 13A, specific areas A3 and A7 shown in FIG. 13B, specific areas A5 and A9 shown in FIG. 13D, and specific areas A1 and A11 shown in FIG. 14A may each be combined into a single specific area.

This reduces the number of specific areas and thereby decreases the processing load imposed during the judgement of whether a touch position is within the specific area.

The respective corners in the vicinity of each of the specific areas are set as shown in FIG. 2.

Also, having the user input handedness information enables the specific areas to be selectively set in the vicinity of only one of the right-hand side and the left-hand side of the touch panel 110 by referencing the handedness information. For example, the specific areas may be set only in the vicinity of the right-hand side of the touch panel 110 for a right-handed user, and only in the vicinity of the left-hand side of the touch panel 110 for a left-handed user. This is done because there is a high probability that a right-handed user will operate the mobile telephone device 100 right-handedly and that a left-handed user with operate the mobile telephone device 100 left-handedly, with a low probability of mistaken operation occurring on the side opposite the holding side.

The user may, of course, select whether to set the specific areas only in the vicinity of the right-hand side or the left-hand side of the touch panel 110.

FIGS. 2, 13A-13D, 14A-14B, and 15A-15D indicate examples in which the specific areas are precisely aligned with the edge of the touch panel 110. However, the specific areas may also be positioned away from the edge of the touch panel 110 to the extent that fingers or the like may touch the touch panel when the user holds the case of the mobile telephone device 100.

Also, in FIGS. 2, 13A-13D, 14A-14B, and 15A-15D, the specific areas are shown as being polygonal. However, circular, triangular, stellate, or other shapes may also be used.

(3) The mobile telephone device 100 pertaining to the Embodiment may be modified to include an acceleration sensor, and may execute display control to match the direction of the screen displayed on the touch panel with the orientation of the case 101, in accordance with detection results from the acceleration sensor.

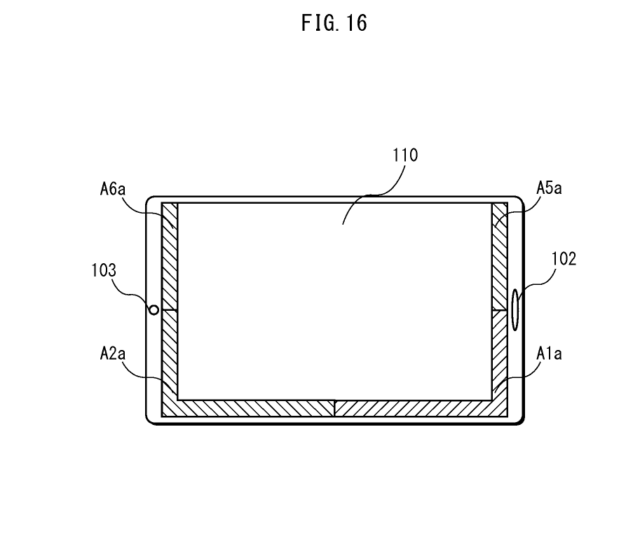

In such cases, the positions of the specific areas may be adjusted in accordance with the orientation of the screen. For example, consider a situation in which the specific areas are set as shown in FIG. 13A, and the user holds the mobile telephone device 100 such that the case 101 of the mobile telephone device 100 is oriented horizontally, with the receiver 102 on the right-hand side and the microphone 103 on the left-hand side. In such a situation, as shown in FIG. 16, specific areas A1 and A5 of FIG. 13A are shifted rightward as specific areas A1a and A5a, and specific areas A2 and A6 are shifted leftward as specific areas A2a and A6a.

(4) In the Embodiment, the scroll display and the magnification display are described as being applied toward a corner in the vicinity of a specific area. However, this is merely intended as an example. The display may also be applied by having the display position of a particular display object approach the detected touch position, the particular display object being distant from the position of the touch in a set positional relationship.

That is, the scroll display and the magnification display may also be performed from the opposite corner toward the touch position.

Also, the scroll display and the magnification display may be performed from a given position within a specific area other than the specific area that includes the touch position, toward the touch position or toward a corner in the vicinity of the specific area that includes the touch position. For example, in the example of FIG. 2, specific areas A1 and A2 may be treated as mutually-opposing specific areas and specific areas A3 and A4 may likewise be treated as mutually-opposing specific areas.

(5) In the Embodiment, when the Specific Area Display Settings are set to Active as shown in FIG. 11, then the scroll display or the magnification display is always performed in accordance with the settings at any time a touch occurs in any of the specific areas. However, the scroll display and the magnification display may also be performed under the set conditions described below. The set conditions are, for example, that a particular application screen is being displayed on the touch panel 110. In such a case, the user may set the Specific Area Display Settings in advance so that the scroll display or the magnification display is performed according to the application.

Accordingly, applications in which the scroll display or the magnification display make for easier operation are distinguished from applications in which the scroll display or the magnification display does not make for easier operation, which improves usability through flexible settings. When the settings indicate that the scroll display and the magnification display are not to be performed, the associated processing is omitted, which lightens the processing load.

(6) In the Embodiments, the amount of scrolling performed in the scroll display and the magnification ratio used in the magnification display are described as being fixed values set in advance by the manufacturer of the mobile telephone device 100. However, these values may also be set in advance by the user.

Accordingly, the scroll display and the magnification display are performed in a manner better suited to user preferences.

The amount of scrolling performed in the scroll display and the magnification ratio used in the magnification display may also be variables. For example, the amount of scrolling performed in the scroll display and the magnification ratio used in the magnification display may be determined proportionately to the surface area and time of the touch in the specific area.

(7) In the Embodiment, the fixed interval tracked by the clock unit 120 of the mobile telephone device 100 is set in advance to approximately 5 seconds, by the manufacturer of the mobile telephone device 100. However, the fixed interval tracked by the clock unit 120 may be any number of seconds set by the user, or may be set according to a selection made by the user among a plurality of time options.

Accordingly, the user is able to set the fixed interval flexibly according to personal preference.

(8) The mobile telephone device 100 pertaining to the Embodiment is described as being a slate terminal. However, no such limitation is intended. Any type of mobile telephone device having a touch panel may be used in any terminal configuration. For instance, a clamshell model or a sliding model of terminal may be applicable.

Also, the mobile telephone device 100 pertaining to the Embodiment is described above as having a touch panel 110 that is substantially rectangular as seen in a plan view. However, the touch panel may be of any shape as seen in the plan view. For instance, a circular or polygonal shape may be applied.

The touch panel 110 is described above as including an LCD. However, the display may also include an organic electroluminescence element or the like rather than the LCD.

(9) The touchpad 112 pertaining to the Embodiment is described as being realised as a capacitive touch sensor.

The capacitive touch sensor may use projected capacitance or surface capacitance. Any form of capacitive touch sensing may be used. Projected capacitance is used by forming a multitude of electrode patterns on a substrate of plastic or glass and measuring the ratio of current between multiple electrode patterns in the vicinity of the touch point to determine the touch position. Surface capacitance is used by forming a conductive film and a substrate, providing electrodes at the corners of the substrate, and forming a uniform electric field over the conductive film, and then measuring the ratio of current at corner terminals caused by contact with a finger or the like to determine the touch position.

No limitation to a capacitive touch sensor is intended for the touchpad 112 detection method. Any method enabling a touch operation by the user to be detected may be used. For example, any of electromagnetic induction with an electron pen or similar stylus, matrix switch in a two-layer assembly of transparent electrodes, resistive sensing in which voltage is applied to one of two resistive films to detect voltage in the other resistive film imparted by an operation, surface acoustic wave sensing in which a finger or the like is detected by detecting a voltage change of a piezoelectric element from a return vibration, infrared sensing in which the position of a finger or the like is detected from the blocking of infrared rays, optical sensing in which the position of a touch is detected on an optical sensor embedded in the configuration of the pixels of the LCD, and so on, may be used.

(10) The components of the mobile telephone device 100 pertaining to the Embodiment may be realised, in whole or in part, as a single chip or as a plurality of chips in an integrated circuit, may be realised by a computer program, and may be realised in any other format.

The functions of each component described above for the mobile telephone device 100 pertaining to the Embodiment are realised by the processor of the mobile telephone device executing computer programs.

(11) The program causing execution of the processing of the mobile telephone device 100 described in the Embodiments (see FIG. 12) may be recorded on a recording medium or distributed and transported through various communication lines. The recording medium may be an IC card, a hard disk, an optical disc, a floppy disc, ROM, flash memory, or similar. The program so distributed is provided for use in a memory or the like readable by the processor, and the functions of the mobile telephone device 100 are realised by the processor executing the control program.
(12) The mobile telephone device 100 pertaining to the Embodiment may be realised with one or more of the variations (1) through (11) applied thereto.
(13) Aspects and variations of the mobile terminal pertaining to the disclosure are further described below, along with the effects thereof.
(a) In one aspect, a mobile terminal includes: a touch panel; a display control unit controlling display of one or more display objects on the touch panel; a detection unit detecting a touch on the touch panel; a judgement unit judging whether a position of the touch detected on the touch panel is within a specific area arranged in advance at a periphery of the touch panel; and an execution control unit executing processing associated with the touch when the judgement unit judges that the position of the touch is not within the specific area, and refraining from executing the processing associated with the touch when the judgement unit judges that the position of the touch is within the specific area, wherein when the judgement unit judges that the position of the touch is within the specific area, the display control unit performs a display update of bringing a display position of a specific display object closer to the position of the touch, the specific display object being distant from the position of the touch in a set positional relationship.

The mobile terminal does not execute the processing corresponding to the touch when the position of the touch on the touch panel is within the specific area provided in advance in the periphery. Thus, according to this aspect of the mobile terminal, when the touch panel is disposed all the way to the edge of the case and a display object such as an icon is displayed in the specific area, mistaken operation is prevented from occurring despite the user accidently making a touch in the display position of the display object in the display area while attempting to make a selection other than that display object.

Also, when the user attempts to select a particular display object and touches the specific area with a finger or the like while attempting to reach the intended display position, the mobile terminal performs a display update to bring the display position of the particular display object closer to the touch position. Accordingly, the mobile terminal enables easier selection of the desired display object for the user by reducing the probability of a further accidental touch with the finger in the specific area.

(b) In another aspect, when the judgement unit judges that the position of the touch is within the specific area, the display control unit performs the display update by shifting the specific display object to a closer position relative to the touch position.

When the user attempts, for example, to select a particular display object and touches the specific area with a finger while attempting to reach the display position of the intended display object, the mobile terminal displays the specific display object in a position shifted closer to the touch position. Accordingly, the mobile terminal enables easier selection of the desired display object for the user by reducing the probability of a further accidental touch with the finger in the specific area.

(c) In a further aspect, the touch panel and a display surface of the touch panel are rectangular as seen in a plane view, and when the judgement unit judges that the position of the touch is within the specific area, the display control unit performs a scroll display of shifting the display objects toward a corner near the specific area from an opposite corner, in terms of position on the touch panel.

When the user attempts, for example, to select a particular display object and touches the specific area with a finger while attempting to reach the display position of the intended display object, the mobile terminal performs a scroll display in which the specific display object is displayed in a position shifted closer to a corner opposite the vicinity of the specific area. Accordingly, the mobile terminal enables easier selection of the desired display object for the user by reducing the probability of a further accidental touch with the finger in the specific area.

(d) In yet another aspect, when the judgement unit judges that the position of the touch is within the specific area, the display control unit performs the display update as a magnification of the specific display object.

When the user attempts, for example, to select a particular display object and touches the specific area with a finger while attempting to reach the display position of the intended display object, the mobile terminal displays a magnification display of the specific display object. Accordingly, the display position of the specific display object is brought closer to the touch position, and thus the mobile terminal enables easier selection of the desired display object for the user by reducing the probability of a further accidental touch with the finger in the specific area.

(e) In yet a further aspect, the touch panel and a display surface of the touch panel are rectangular as seen in a plane view, and when the judgement unit judges that the position of the touch is within the specific area, the display control unit performs the magnification of the specific display object relative to an opposite corner position opposite a corner near the specific area, in terms of position on the touch panel.

When the user attempts, for example, to select a particular display object and touches the specific area with a finger while attempting to reach the display position of the intended display object, the mobile terminal displays a magnification display of the specific display object with reference to a position opposite the corner in the vicinity of the specific area. Accordingly, the display position of the specific display object is brought closer to the touch position, and thus the mobile terminal enables easier selection of the desired display object for the user by reducing the probability of a further accidental touch with the finger in the specific area.

(f) In still another aspect, a clock unit clocks time elapsed since the detection by the detection unit of the touch on the touch panel, and when the judgement unit judges that the position of the touch is within the specific area, and at least a fixed time has elapsed, the display control unit reverts a display state of the touch panel to before the display update.

When the user makes a touch with the finger in the specific area that continues longer than a fixed interval, the mobile terminal reverts the display state to conditions before the update bringing the display position of the display object closer to the touch position. Accordingly, when the user touches the specific area with the finger for longer than the fixed interval, the display state is reverted on the assumption that the user does not intend to select any specific display object.

(g) In still a further aspect, when the judgement unit judges that the position of the touch is not within the specific area, and the position of the touch is within a display range of one of the display objects displayed on the touch panel, the display control unit executes processing associated with the one of the display objects.

The mobile terminal executes processing associated with a display object displayed in the touch position when the touch position on the touch panel is not within the specific area.

(14) The touch panel, the clock unit, the detection unit, the judgment unit, the execution control unit, and the display control unit of the mobile terminal pertaining to the disclosure respectively correspond to the touch panel 110, the clock unit 120, the detection unit 141, the judgment unit 142, the execution control unit 143, and the display control unit 144 of the mobile telephone device 100 pertaining to the Embodiment.

### INDUSTRIAL APPLICABILITY

The mobile terminal pertaining to the disclosure is applicable to situations where a user makes an operation using a touch panel.

### REFERENCE SIGNS LIST

100 Mobile telephone device
101 Case
102 Receiver
103 Microphone
110 Touch panel
111 LCD
112 Touch pad
113 Controller
120 Clock unit
130 Storage unit
140 Control unit
141 Detection unit
142 Judgement unit
143 Execution control unit
144 Display control unit

1. A mobile terminal, comprising:
a touch panel;
a display control unit controlling display of one or more display objects on the touch panel;
a detection unit detecting a touch on the touch panel;
a judgement unit judging whether a position of the touch detected on the touch panel is within a specific area arranged in advance at a periphery of the touch panel; and
an execution control unit executing processing associated with the touch when the judgement unit judges that the position of the touch is not within the specific area, and refraining from executing the processing associated with the touch when the judgement unit judges that the position of the touch is within the specific area, wherein
when the judgement unit judges that the position of the touch is within the specific area, the display control unit performs a display update of bringing a display position of a specific display object closer to the position of the touch, the specific display object being distant from the position of the touch in a set positional relationship.

2. The mobile terminal of claim 1, wherein
when the judgement unit judges that the position of the touch is within the specific area, the display control unit performs the display update by shifting the specific display object to a closer position relative to the touch position.

3. The mobile terminal of claim 2, wherein
the touch panel and a display surface of the touch panel are rectangular as seen in a plane view, and
when the judgement unit judges that the position of the touch is within the specific area, the display control unit performs a scroll display of shifting the display objects toward a corner near the specific area from an opposite corner, in terms of position on the touch panel.

4. The mobile terminal of claim 1, wherein
when the judgement unit judges that the position of the touch is within the specific area, the display control unit performs the display update as a magnification of the specific display object.

5. The mobile terminal of claim 4, wherein
the touch panel and a display surface of the touch panel are rectangular as seen in a plane view, and
when the judgement unit judges that the position of the touch is within the specific area, the display control unit performs the magnification of the specific display object relative to an opposite corner position opposite a corner near the specific area, in terms of position on the touch panel.

6. The mobile terminal of claim 1, further comprising
a clock unit clocking time elapsed since the detection by the detection unit of the touch on the touch panel, wherein
when the judgement unit judges that the position of the touch is within the specific area, and at least a fixed time has elapsed, the display control unit reverts a display state of the touch panel to before the display update.

7. The mobile terminal of claim 1, wherein
when the judgement unit judges that the position of the touch is not within the specific area, and the position of the touch is within a display range of one of the display objects displayed on the touch panel, the display control unit executes processing associated with the one of the display objects.

8. A control method for a mobile terminal that includes a touch panel, the control method comprising:
a first display control step of displaying one or more display objects on the touch panel;
a detection step of detecting a touch on the touch panel;
a judgement step of judging whether a position of the touch detected on the touch panel in the detection step is within a specific area arranged in advance at a periphery of the touch panel;
an execution control step of executing processing associated with the touch when the position of the touch is judged in the judgement step to not be within the specific area, and refraining from executing the processing associated with the touch when the position of the touch is judged in the judgement step to be within the specific area; and
a second display control step of, when the position of the touch is judged in the judgement step to be within the specific area, performing a display update of bringing a display position of a specific display object closer to the position of the touch, the specific display object being distant from the position of the touch in a set positional relationship.

9. A program for causing a processor in a mobile terminal that includes a touch panel to execute a control process, the control process comprising:
a first display control step of displaying one or more display objects on the touch panel;
a detection step of detecting a touch on the touch panel;
a judgement step of judging whether a position of the touch detected on the touch panel in the detection step is within a specific area arranged in advance at a periphery of the touch panel;
an execution control step of executing processing associated with the touch when the position of the touch is judged in the judgement step to not be within the specific area, and refraining from executing the processing associated with the touch when the position of the touch is judged in the judgement step to be within the specific area; and
a second display control step of, when the position of the touch is judged in the judgement step to be within the specific area, performing a display update of bringing a display position of a specific display object closer to the position of the touch, the specific display object being distant from the position of the touch in a set positional relationship.
